(19) United States
(12) Patent Application Publication
(10) Pub. No.: US 2026/0002458 A1
(43) Pub. Date: Jan. 1, 2026

(54) METHOD FOR BRAKING A LOW-OVERPRESSURE GAS FLOW

(71) Applicants: Denis Ernestovich LVOV, Saint-Petersburg (RU); Timofei Aleksandrovich DORONIN, rp. Bykovo (RU); Aleksei Dmitrievich GOLUBEV, g. Vsevolozhsk (RU)

(72) Inventors: Denis Ernestovich LVOV, Saint-Petersburg (RU); Timofei Aleksandrovich DORONIN, rp. Bykovo (RU); Aleksei Dmitrievich GOLUBEV, g. Vsevolozhsk (RU)

(21) Appl. No.: 18/992,234

(22) PCT Filed: Jul. 22, 2022
(86) PCT No.: PCT/RU2022/000233

§ 371 Date: Jan. 8, 2025

(51) Int. Cl. F01N 1/08; F15D 1/10

(52) U.S. Cl. CPC F01N 1/08; F15D 1/10

(57) ABSTRACT

The method for decelerating the gas flow with a low gauge pressure can be used to decelerate gas flows containing particles coaxially moving together with the gas flow that are not homogeneous to the gas flow, for example, inclusions that are solid, liquid, plasma, and the like body or bodies. In this case, the gas flow acts as a carrier flow for these particles (inclusions). This method is designed to decelerate the gas component of a carrier flow, and for the subsequent separation of inclusions from the carrier flow, energy recovery of the carrier gas flow, separation of particles with different masses, as well as sputtering particles on any surfaces due to moving separately from this flow and/or carried together with gas flows distributed by the proposed method. The inclusions or particles may have a diverse nature, for example, solid particles of various masses, or liquid that is further divided into droplets, plasma, or other types of inclusions.

### FIELD OF APPLICATION

The method for decelerating the gas flow with a low gauge pressure can be used to decelerate gas flows containing particles coaxially moving together with the gas flow that are not homogeneous to the gas flow, for example, inclusions that are solid, liquid, plasma, and the like body or bodies. In this case, the gas flow acts as their carrier flow for these particles (inclusions).

### PURPOSE

This method is designed to decelerate the gas component of a carrier flow, and for the subsequent separation of inclusions from the carrier flow, energy recovery of the carrier gas flow, separation of particles with different masses, as well as sputtering particles on any surfaces due to moving separately from this flow and/or carried together with gas flows distributed by the proposed method. The inclusions or particles may have a diverse nature, for example, solid particles of various masses, or liquid that is further divided into droplets, plasma, or other types of inclusions.

### PRIOR ART

From the prior art, utility model “A Muzzle Brake (MB)”, is known, patent 2 744 219, published on Mar. 3, 2021, IPC F41A 21/36, comprising a housing with series-connected coaxial chambers with working zones in a through channel provided with through holes that are oriented perpendicular to the axis of the barrel. However, the working chambers are designed to brake the barrel's recoil of the weapon, as well as to reduce or compensate for the tossing of the barrel that utilizes the reactive force of gases for its functioning.

This device is intended to reduce the recoil by decelerating and turning the gas jet with a series of successive chambers, however, this device does not provide deceleration of a low-pressure jet since the device will not work effectively because its chambers are directly connected in series with each other without providing the incoming gas with the possibility of bypassing (flowing around) them. In essence, they are “communicating vessels” in which the pressure will inevitably equalize in the gas outflow. At the same time, after filling the formed side “pockets” with outflowing gas, the pressure will inevitably equalize and the total gas-dynamic resistance of the system of such chambers will be low.

Such a method of deceleration a gas flow with the organization of a zone with a straight shock wave on its way is effective only for gas flows with a high gauge pressure (which will be sufficient to expand the flow to the size of an obstacle causing the straight shock wave and acceleration of the flow to supersonic velocity) and will not work for gas flows with a low gauge pressure, where gases are unable to expand to the required cross-sectional size and gain a velocity above the velocity of sound.

The invention “A Muzzle-Attached Device for Smooth-Bore Hunting Weapons” is known, patent RU 2 709 294, published on Dec. 17, 2019, IPC F41A 21/30, F41C 7/11, in which the silencer is used for weakly powerful firearms, such as a shotgun. A traditional partition and a number of chambers (at least two) are used in a linear tubular channel in the form of a cylindrical frame extending along the inner part of the silencer. The flow of powder gases from the chamber with a volume of VI to the second chamber with a larger volume of V2 is used. In the process of this overflow, when gases pass through this narrow slit, the sound force of the shot is reduced by removing heat to the housing of the muzzle-attached device and the housing of the inner tube. However, with such an organization of the gas flow movement, there will be no separation of inclusions from the main gas flow; in addition, the carried particles can damage the housing when they are in direct contact with the housing.

The invention “A Method for Purifying Gases from Impurities” is known, patent RU 2 757 240, IPC F25J3/06, B01D53/00, B01D7/02, published on Oct. 12, 2021, in which the gas flow comes into the working chamber, to the inlet of which an additional flow of solid particles is supplied. Extracted gas components are desublimated on the surface of the solid particles, after which the solid and gas phases are separated in a cyclone. The working chamber is a channel of variable cross-section, in which the diameter of the inlet cross-section of the working chamber coincides with the diameter of the outlet cross-section of the nozzle. It is used to purify gases, for which controlled condensation is used. However, the desublimation of gas nuclei is achieved by introducing solid particles into the gas flow, but not by decelerating this gas flow and separating the particles. This device will not allow the straight-moving particles carried by the gas flow to continue their straight motion in the tubular channel.

The closest technical solution is the utility model “A Silencer for Pneumatic Weapons”, patent RU 206 121, published on Aug. 24, 2021, IPC F41A 21/30, in which due to the presence of a through hole and the rapid closure of this hole behind the flying bullet, as well as the isolation of expanding portions of gases in separate, relatively sealed (expansion) chambers, the noise level is reduced. However, the use of the traditional method of deceleration of a gas flow with devices of this type or the use of the traditional labyrinth type will not allow foreign bodies moving rectilinearly together with the flow, which are carried by the gas flow, to continue their continuous straight movement in the tubular channel, provided that there is a constant, continuous outflow of particles, and not just a flight of one body, for example, a bullet. Moreover, it does not ensure the destruction of the homogeneity of the gas flow rate distribution over the cross-section with an increase in rate from the center to the periphery of the gas flow.

Therefore, the methods of deceleration of a gas flow with a low gauge pressure known from the prior art and devices of known types will either not apply to the case of deceleration of a gas flow with a low gauge pressure and inhomogeneous inclusions, or will not give the efficiency that they could feature.

### Inventive Problem

The gas dynamics show that the most effective way to decelerate a gas flow is to set obstacles that can cause this flow to consistently perform a series of turns, for example, on labyrinth-type obstacles or in a porous medium. For each such turn, a portion of the kinetic energy of the gas flow will be consumed, which through internal friction will be converted into the potential energy of the flow in the form of an increase in its temperature. However, there are cases when the installation of such obstacles preventing the rectilinear flow is not possible, in particular, when, together with a gas jet, for example, in its central part, a body or bodies follows, for which it is required to ensure unhindered straight passage. At the same time, the gas flow entraining these bodies should be decelerated as much as possible and separated.

To solve such a problem, for example, in the case of a flat current (river flow type), a “pocket” can be organized on the side of the main channel, the geometric dimensions and shape of which would make it possible for a stationary vortex cyclic flow to exist in it. In such a “pocket”, the moving flow swirls under the action of centrifugal force and will be forced to the periphery of the “pocket”, as in a snail-type whistle or in a cyclone filter. Due to this effect, an area of high pressure is created on the path of the main flow, which is an obstacle to the flow that decelerates it and directs it to the zone of lower resistance. However, the high-pressure zone can be designed in such a way that it is not a significant obstacle to the passage of particles (inclusions) that move along with the gas flow, which will continue to move straight along the channel. The possibility of straight passage of particles through the high-pressure zone is provided due to the mass and velocity of these particles, which, having incomparably greater momentum than the gas molecules, will continue their straight motion by inertia. Thus, the body or bodies following together with the flow can continue to follow straight along the main channel. The pressure in the working zone is calculated based on the ratio of gas nuclei masses and the inclusion particles' mass. For the case of a volume gas flow with inclusions, an analogue of such a “pocket” will be a zone made around the main channel and having the shape of a toroidal recess, in which the swirl of the gas flow entering such a “pocket” will have the shape of a toroidal vortex.

A toroidal vortex is understood as a forced stationary vortex flow of gas organized in a toroidal “pocket” located around the main channel of the flow. In general, the toroidal vortex is similar to the vortex flow of gas in snail-type whistles, while the gas moving in this vortex flow under the action of centrifugal force will tend to move away from the center of its rotation and “pinch” the central flow channel of the main gas flow, thereby creating an area of increased pressure and dynamic resistance, and the main flow that enters this area will experience deceleration and at the same time it will be redirected to the periphery.

In this case, the problem of gas flow deceleration with unimpeded straight passage of inclusions entrained by this flow will be solved.

### Technical Result

The proposed technical solution provides the following technical result:
deceleration of the gas component of a flow and its deflection to the periphery without a significant impact on the velocity of bodies (inclusions) moving coaxially and together with the gas flow;
destruction of the homogeneity of the distribution of the gas flow rate over its cross-section with an increase in the gas flow rate from the center to the periphery of the gas flow; i.e., when the obstacle is rounded, most of its mass is carried by the flow bypassing the obstacle, and, accordingly, the total mass flow rate over the cross-section becomes smaller in the center and larger in the periphery.

### Embodiment of the Invention

The technical result is achieved due to the fact that the method of deceleration of a gas flow is implemented that includes deceleration of a gas flow with a low gauge pressure not exceeding 10 atm. For this purpose, an obstacle oriented perpendicular to the gas flow and equipped with a vortex chamber coaxially oriented to the gas flow's longitudinal axis is placed in a housing. The passage of one part of the gas flow through the through-hole of the obstacle with a vortex chamber is provided so that passage of a body or bodies foreign to the main gas flow and moving coaxially with the flow is possible due to the through-hole with a diameter of d1 made in the obstacle. The forced flow around by the other part of the gas flow outside this obstacle is organized by supplying the obstacle with a vortex chamber, inside which a swirling gas flow is created, while the flow around is provided due to the geometric relations of the inner cavity of the vortex chamber of the obstacle creating inside it (the vortex chamber) the increased resistance to the through passage of the gas flow through the through-hole of this obstacle.

New in the proposed technical solution is that a tubular-shaped housing is placed downstream of the end of the gas flow source channel, thus forming a through channel. Due to the tubular shape of the housing, which has the outer diameter at least three times larger than the inner diameter of the source channel, at least one working zone “a” coaxial to the source channel is formed upstream of the obstacle with a vortex chamber. In a particular case, it is possible to form several working zones arranged sequentially and coaxially with the source channel. To form the working zone, an obstacle with a vortex chamber is placed perpendicular to the through channel and coaxial to its axis. The through-hole d1 of the obstacle should be not smaller than the diameter of the source channel d and the distance “h” between the end of the source channel and the front edge of the obstacle with a vortex chamber should be provided. Or, as a particular case, the distance “h” is provided between the corresponding front edge of the subsequent obstacle and the rear edge of the neighboring obstacle with a vortex chamber. The distance “h” has a value not less than half (>=½) of the diameter “d1” of the through-hole in the obstacle. Due to this, a stable vortex is formed inside the obstacle at the ratio of the geometric dimensions of the vortex chamber made in the form of a three-dimensional toroid washer with the length “L” and equal to at least the value “d1”, and with the diameter “D” equal to at least two “d1”, which has a cone-shaped outer surface in the front part and a flat surface or a conical or cylindrical inner surface in the rear part made with a through-hole with the diameter “d1”. In this case, the working zone “a” is formed between the end of the gas flow source channel with inclusions and the front edge of the obstacle with a vortex chamber, in which the incoming gas flow has an increased internal gas-dynamic resistance that prevents (inside the chamber) the passage of the gas flow through the through-hole “d1”. As a result, the gas flow is forced to separate and one part of the gas flow will be forced to go around the obstacle, while the other part of the gas flow, together with the inclusions moving in it (heavy solid particles with high inertia), will continue to move through the obstacle hole “d1”. The distance “h” required to enable the gas flow to turn and go around the obstacle is calculated based on the pressure difference inside and outside the gas flow, considering the velocity, density, and viscosity of the outflowing gas.

In a particular case, the length of each working zone can be formed not less than half the diameter of the hole “d1”.

Thus, inside the vortex chamber of the obstacle, due to the fulfillment of geometric conditions in the ratio of parameters “d”, “d1”, “D”, “L” and “h”, a stationary toroidal vortex is formed and a high-pressure zone is created. This zone exerts an increased gas-dynamic resistance to the incoming flow forcing part of the incoming flow to deviate and go around this obstacle. The working zone is located coaxially with the source channel. To form a stationary toroidal vortex inside the chamber, the chamber itself is made with the outer diameter “D” numerically equal to at least two diameters of the hole “d1” in this obstacle and the length of at least one “d1”. In the working zone “a”, an area of high pressure is formed, which acts as a single composite obstacle.

In the proposed method, the deceleration and deflection of the gas flow (1) are implemented by fulfilling the conditions of occurrence of the area of high pressure “a” inside the obstacle (2) placed on axis (X-X) of the gas flow with a vortex chamber (3) closing the hole (4) for passage of a body or bodies that move coaxially (X-X) to the gas flow, due to the fulfillment of the conditions for the occurrence of the vortex flow in the form of a toroidal vortex (“b”) in the obstacle (2). The outer wall (5) of the obstacle (2) facing the incoming flow (1), if possible, should have a streamlined (for example, conical) shape. As used herein, these obstacles are referred to as obstacles with a vortex chamber (3). Then, as a result of running of gas flow (1) with inclusions on the obstacle (2), the gas flow will experience increased resistance to the continuation of its straight motion and will be forced to go around this obstacle (2) and deviate. At the same time, the possibility of unobstructed straight movement of the body (bodies) moving coaxially with the gas flow (1) will be preserved. In this case, the gas flow (1) upstream of the obstacle (2) in the main part is deflected (1′), and part of the molecules of the gas flow (1), together with inclusions (solid particles), passes rectilinearly through the hole (4) of the obstacle (2) by inertia.

The inclusion or body can be either a single body discharged from the source channel into the housing through a channel or a mass of particles, such as sand, shot, or droplets in a liquid jet.

The proposed design is illustrated by a drawing that does not cover all embodiments.

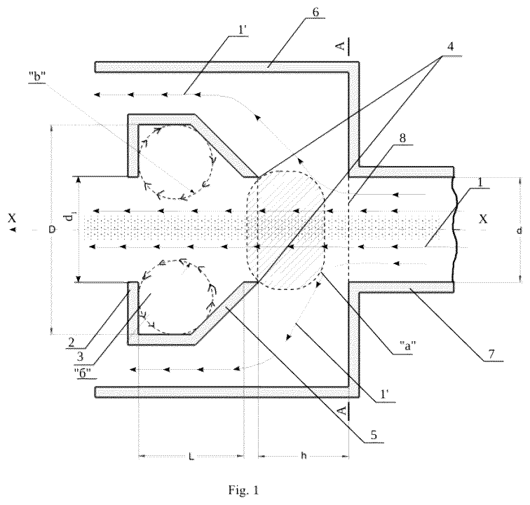

FIG. 1 shows a gas flow outflowing from the source channel and going around the obstacle.

### Implementation of the Method

A design implementing this method of decelerating a gas flow can be made as follows. In a cylindrical housing (6) made, for example, in the form of a tubular nozzle, there is an inlet channel (source channel) (7) having an opening (8) with the diameter “d”, from which gas flow (1) with inclusions flows out, and at least one special obstacle (2) is placed, made as an obstacle with a vortex chamber (3). The obstacle (2) with the vortex chamber (3) is located in the housing (6) perpendicular to the gas flow (1) and coaxial to its axis (X-X); it has a through-hole (4) for passage of the body (or bodies) moving coaxially with the gas flow. The ratio of the geometric dimensions of the obstacle (2) with the vortex chamber (3) is as follows: the diameter of the hole “d1”, the length “L” and the diameter “D” of the vortex chamber (3) of the obstacle (2) meet the conditions for the formation of a stationary toroidal vortex (“b”) inside it creating an area of high pressure inside this chamber that extends towards the oncoming flow and forms a working zone (“a”). The distance “h” to the obstacle (2) provides the conditions sufficient for the flow (1) to go around the obstacle (2) with the vortex chamber (3). The obstacle (2) together with the toroidal vortex “b” in the vortex chamber (3) form one composite obstacle, upstream of which one working zone (“a”) is formed, located coaxially with the source channel (7) and the housing (6). Several such working zones “a” can be arranged in series and coaxially by placing several obstacles (2) with vortex chambers (3) in series. The distance “h” between the end (the hole) (8) of the source channel (7) and the obstacle (2) with the vortex chamber (3), or two adjacent obstacles with the vortex chamber (3), respectively, is calculated based on the pressure difference inside the gas flow (1) and outside it, as well as the velocity, density, and viscosity of the outflowing gas; it is equal to at least half the diameter of the through-hole “d1” in the corresponding obstacle (2) with the vortex chamber (3). The through-hole (4) in the obstacle (2) with the vortex chamber (3) of diameter “d1” is intended for the unobstructed passage of a body (or bodies) moving coaxially with the gas flow. The inner diameter “D” of the vortex chamber (3) of the obstacle (2) is numerically equal to at least two diameters of the through-hole “d1” (4) and the length “L” is not less than one “d1”, which is usually equal to or slightly larger than the diameter “d” of the source channel (8). The rear wall of the obstacle (2) can be made flat. The shape of the inner walls of the vortex chamber (3) of the obstacle (2) does not have a significant effect on the formation of the vortex flow (toroidal vortex “b”).

The proposed method is implemented as follows.

The gas flow (1) outflowing from the source channel (7) into the housing (6) enters the vortex chamber (3) of the obstacle (2), swirls, and creates a toroidal vortex flow (“b”) inside this chamber, the gas molecules in which, being forced to move along circular trajectories, deflect under the action of centrifugal force and form an area of high pressure on the outer surfaces of the torus (including those facing its central part) extending towards the oncoming flow and forming the working zone “a”, which decelerates the outflowing gas flow.

The minimum possible distance “h” to the obstacle (2) necessary for the gas flow (1) to deviate and go around the obstacle (2) is calculated based on the pressure difference in the inlet cross-section (A-A) of the outflow point and in the outflow zone, as well as the velocity, density, and viscosity of the outflowing gas. Usually, this value can not be less than half the diameter of the cross-section of the flow (1).

The gas flow begins to “perceive” the rigid body of the obstacle (2) with the vortex chamber (3) and the formed high-pressure zone “a”, which plays the role of a virtual “filler” of the hole (4), as a single integral obstacle (2) providing increased dynamic resistance to the movement of the flow (1) in the axial direction (X-X). As a result, the gas flow (1) will be forced not only to decelerate but also to flow around the obstacle (2). Thus, in the part of the flow (1′) going around the obstacles (2), the gas flow rate will be greater than in the opening (4), i.e., the density of the total flow over the cross-section will be redistributed to the walls of the housing (6). In this case, the body (or bodies) moving coaxial to the flow and smaller than the diameter “d1” can continue following in the axial direction.

All parameters can be initially calculated analytically and selected based on the results of numerical computer simulation of gas outflow using the finite element method based on the solution of the Novier-Stokes gas equations.

In addition to effective deceleration of the flow characterized by a high value of the coefficient of the ratio of the loss of flow velocity to the length of the deceleration distance, a side effect, as a result of the need for the flow to bend around the obstacle (2) from the outside, will also be the destruction of the homogeneity of the gas flow density distribution over the cross-section (A-A) with an increase in the gas flow rate along walls of the housing (6) instead of its axis (X-X), which creates additional engineering conveniences for its further diversion, deceleration, cooling, recuperation, etc. The body or bodies following along the axis (X-X) of the flow (1) will obtain the possibility to continue the straight movement.

The conducted field tests demonstrated good compliance of the results of practical tests with the results of computer simulation.

1. A method for decelerating the supersonic gas flow with a low gauge pressure, including placement of an obstacle oriented perpendicular to the gas flow and equipped with a vortex chamber oriented coaxially to the longitudinal axis of the gas flow in a housing, passage of one part of the gas flow through the through-hole of the obstacle with a vortex chamber so that passage of a body or bodies foreign to the main gas flow and moving coaxially with the flow is possible due to the through-hole with a diameter of d1 made in the obstacle, organization of the forced flow around by the other part of the gas flow outside this obstacle by supplying the obstacle with a vortex chamber, inside which a swirling gas flow is created, while the flow around is provided due to the geometric relations of the inner cavity of the vortex chamber of the obstacle creating inside it the increased resistance to the through passage of the gas flow through the through-hole of this obstacle, characterized in that a tubular-shaped housing is placed downstream of the end of the gas flow source channel, thus forming a through channel, due to the tubular shape of the housing, which has the outer diameter at least three times larger than the inner diameter of the source channel, at least one working zone “a” coaxial to the source channel is formed upstream of the obstacle with a vortex chamber, for which an obstacle with a vortex chamber is placed perpendicular to the through channel and coaxial to its axis; the through-hole d1 of the obstacle is not smaller than the diameter of the source channel d and the distance “h” between the end of the source channel and the front edge of the obstacle with a vortex chamber is provided, or between the corresponding front edge of the subsequent obstacle and the rear edge of the neighboring obstacle with a vortex chamber; the distance “h” has a value not less than half (>=½) of the diameter “d1” of the through-hole in the obstacle; a stable vortex is formed inside the obstacle at the ratio of the geometric dimensions of the vortex chamber made in the form of a three-dimensional toroid washer with the length “L” and equal to at least the value “d1”, and with the diameter “D” equal to at least two “d1”, which has a cone-shaped outer surface in the front part and a flat surface or a conical or cylindrical inner surface in the rear part made with a through-hole with the diameter “d1”; in this case, the working zone “a” is formed between the end of the gas flow source channel with inclusions and the front edge of the obstacle with a vortex chamber, in which the incoming gas flow has an increased internal gas-dynamic resistance that prevents the passage of the gas flow through the through-hole d1, resulting in that the gas flow is forced to separate and one part of the gas flow is forced to go around the obstacle, while the other part of the gas flow, together with the inclusions moving in it continues to move through the obstacle hole d1; the distance “h” is calculated based on the pressure difference inside the gas flow and outside it, taking into account the velocity, density and viscosity of the outflowing gas.

2. A supersonic gas flow deceleration method according to claim 1, characterized in that several working zones are formed, arranged in series, and coaxially with the source channel.

3. A supersonic gas flow deceleration method according to claim 2, characterized in that a length of each working zone of at least half diameter of the hole “d1” is formed.
